(19) United States
(12) Patent Application Publication
(10) Pub. No.: US 2013/0054318 A1
(43) Pub. Date: Feb. 28, 2013

(54) MARKETING SYSTEM AND METHOD FOR HEARING AID

(71) Applicant: Youngsoo Jarng, Gwangju (KR)

(72) Inventor: Youngsoo Jarng, Gwangju (KR)

(21) Appl. No.: 13/283,339

(22) Filed: Oct. 27, 2011

(30) Foreign Application Priority Data
Aug. 26, 2011 (KR) 10-2011-0086005

(51) Int. Cl. G06Q 30/02

(52) U.S. Cl. 705/14.4

(57) ABSTRACT

Provided is a marketing system and method for a hearing aid. A customized inner ear type hearing aid is manufactured using measurement data collected from a plurality of users who demand customized hearing aids, and the collected measurement data is classified into a plurality of groups to generate representative measurement data of each group, thereby manufacturing a general-purpose inner eye type hearing aid. In addition, the manufactured general-purpose inner ear type hearing aid allows a user to directly perform hearing examination and fitting work, and so a user who wants to use a general-purpose inner ear type hearing aid may purchase a suitable general-purpose inner ear type hearing aid without any help of a specialist and use it instantly. Therefore, manufacturing and selling costs may be greatly reduced, and the hearing aid market may be expanded since hearing aids may be purchased at places ensuring each access of users.

### CROSS-REFERENCE TO RELATED APPLICATIONS

This application claims priority under 35 U.S.C. §119 to Korean Patent Application No. 10-2011-0086005, filed on Aug. 26, 2011, in the Korean Intellectual Property Office, the disclosure of which is incorporated herein by reference in its entirety.

### TECHNICAL FIELD

The following invention relates to a marketing system and method for a hearing aid, and in particular, to a marketing system and method for a hearing aid which may be easily accessed and may be directly used by a user.

### BACKGROUND

Generally, a hearing aid is classified depending on amplification methods, circuit characteristics and shapes. The classification depending on the amplification methods means that hearing aids are classified depending on the fact that they amplify sound in a linear type or in a non-linear type. The circuit characteristics classify hearing aids whether they are implemented with an analog circuit or a digital circuit. However, the kinds of hearing aids are generally classified depending on shapes of the hearing aids.

Depending on shapes, hearing aids may be classified into pocket type (or, box type) hearing aids, earring type (Behind-The-Ear: BTE) hearing aids, inner ear type (In-The-Ear: ITE, In-The-Car: ITC) or eardrum type (Completely-In-the-Canal: CIC) hearing aids, and eyeglass type hearing aids. Among them, the inner ear type hearing aid is most preferred by users since the hearing aid is substantially not observed from the outside.

In case of an existing inner ear type hearing aid, an ear pattern is collected to measure shape and size of the external auditory meatus of an individual user, and a hearing aid is made according to the collected ear pattern in a customized way. The ear pattern collecting process must be accompanied with the advice of a specialist, and the production efficiency of the hearing aid is very low since the hearing aid must be manufactured based on the collected ear pattern.

Since an existing inner ear type hearing aid is produced by a customized manufacturing process as described above, the hearing aid requires a very high production cost and long manufacturing time, and it may not be instantly used when a user needs.

The appearance of a hearing aid such as a pocket type hearing aid, an earring type hearing aid, an eyeglass type hearing aid and a necklace type hearing aid, other than the inner ear type hearing aid may not be manufactured in a customized way, but a fitting work for setting a sound amplification characteristic of the hearing aid suitably for the user should be performed, and therefore a specialist is still necessary.

### SUMMARY

An embodiment of the present invention is directed to providing a marketing system for a hearing aid, which allows the hearing aid to be easily accessed and instantly used by a user without any help of a specialist.

An embodiment of the present invention is also directed to providing a marketing method for a hearing aid for the above system.

In one general aspect, a marketing system for a hearing aid includes: a manufacturing system for generating a plurality of measurement data for each of a plurality of collected ear patterns, and manufacturing a customized inner ear type hearing aid corresponding to the plurality of measurement data and a general-purpose inner ear type hearing aid corresponding one or more representative measurement data; a marketing server for receiving and storing the plurality of measurement data and first and second user information respectively corresponding to the plurality of measurement data, classifying the plurality of stored measurement data into one or more groups according to a predetermined pattern, and then statistically treating the plurality of measurement data of each group to generate the representative measurement data; a first selling system for receiving the first user information for a first user who wants to use the customized inner ear type hearing aid and transmitting the first user information to the marketing server, and transmitting first hearing data which is a hearing examination result of the user and first fitting data which is a fitting result of the customized inner ear type hearing aid according to the first hearing data to the marketing server; and a second selling system for receiving the second user information for a second user who wants to use general-purpose inner ear type hearing aid and transmitting the second user information to the marketing server, and transmitting second hearing data which is a hearing examination result of the second user and second fitting data which is a fitting result of the general-purpose inner ear type hearing aid according to the second hearing data to the marketing server.

The manufacturing system may include: a first measuring device for quantitatively measuring each of the plurality of collected ear patterns to generate the plurality of measurement data; an input and control device for receiving the measurement data and transmitting the measurement data to the marketing server, and receiving the measurement data and the representative measurement data applied from the marketing server; and a manufacturing device for manufacturing the customized inner ear type hearing aid corresponding to the measurement data and manufacturing a general-purpose inner ear type hearing aid corresponding to the representative measurement data, by the control of the input and control device.

When the measurement data is added, the marketing server may include the added measurement data in a corresponding one of the one or more groups and then statistically treating a plurality of measurement data included in the added measurement data to update the representative measurement data.

The first selling system may include: a first hearing examining device for performing hearing examination to the first user to generate the first hearing data; a first fitting device for fitting the customized inner ear type hearing aid based on the first hearing data and generating first fitting data; and a data input device for transmitting the first user information for the first user, the first hearing data and the first fitting data to the marketing server.

The first selling system may be implemented at a hearing aid specialty store.

The second selling system may include: a second hearing examining device for performing hearing examination to the second user to generate the second hearing data; and a second fitting device for fitting the general-purpose inner ear type hearing aid based on the second hearing data to generate the second fitting data, and transmitting the second fitting data to the marketing server.

The second selling system may be implemented at a simple hearing aid store, and the simple hearing aid store is included in any one of department stores, supermarkets and discount stores.

In another aspect, there is provided a marketing method for a hearing aid of a hearing aid marketing system including a manufacturing system, a marketing server, a first selling system and a second selling system, the marketing method including: storing a plurality of measurement data applied from the manufacturing system to the marketing server; performing statistical treatment to the plurality of stored measurement data to update one or more representative measurement data; the manufacturing system manufacturing a customized inner ear type hearing aid based on measurement data corresponding to the user among the plurality of measurement data or a general-purpose inner ear type hearing aid based on the representative measurement data according to a request of the user; examining hearing of the user by means of a hearing examining device provided at the first selling system or the second selling system to generate hearing data; and fitting the customized inner ear type hearing aid and the general-purpose inner ear type hearing aid by means of a fitting device provided at the first selling system or the second selling system in a response to the hearing data.

The storing of the plurality of measurement data may include: inputting user information of the user by means of the first and second selling systems; determining whether measurement data for the user, previously stored, is present in the marketing server; determining whether or not to use the previous measurement data, in a case where the previous measurement data is present; measuring an ear pattern of the user to generate the measurement data in a case where the previous measurement data is not present in the manufacturing system or in a case where the previous measurement data is present but is not used; and storing the generated measurement data in the marketing server to be matched with the stored user information.

The updating of the representative measurement data may include: classifying the plurality of measurement data into one or more groups according to a predetermined pattern; statistically treating a plurality of measurement data of each group to generate the one or more representative measurement data; when new measurement data is additionally applied, including the added measurement data in one of the plurality of groups; and further statistically treating the group including the added measurement data to update representative measurement data corresponding to the group.

The fitting may include: starting the fitting to operate the fitting device; analyzing hearing data applied from the hearing examining device; automatically fitting the customized inner ear type hearing aid and the general-purpose inner ear type hearing aid connected to the fitting device in a response to the analyzed hearing data; selecting a user circumstance where the automatically fit hearing aid is generally used; performing additional fitting to the automatically fit hearing aid according to the user circumstance; determining whether or not to perform supplementary fitting to the hearing aid to which the additional fitting is performed; performing supplementary fitting according to a setting of the user, in a case where the supplementary fitting is to be performed; checking a fitting result of the hearing aid to which the additional fitting or supplementary fitting is performed; and storing the fitting result in the marketing server to be matched with the user information.

Other features and aspects will be apparent from the following detailed description, the drawings, and the claims.

### BRIEF DESCRIPTION OF THE DRAWINGS

The above and other objects, features and advantages of the present invention will become apparent from the following description of certain exemplary embodiments given in conjunction with the accompanying drawings, in which:

FIG. 1 shows a marketing system for a hearing aid according to an embodiment of the present invention;

FIG. 2 is a diagram showing an example of measurement data;

FIG. 3 shows a marketing method for a hearing aid according to an embodiment of the present invention;

FIG. 4 is a diagram showing a measurement data storing operation of FIG. 3 in detail; and

FIG. 5 is a diagram showing a fitting operation of FIG. 3 in detail.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein.

Hereinafter, exemplary embodiments will be described in detail with reference to the accompanying drawings. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments.

As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

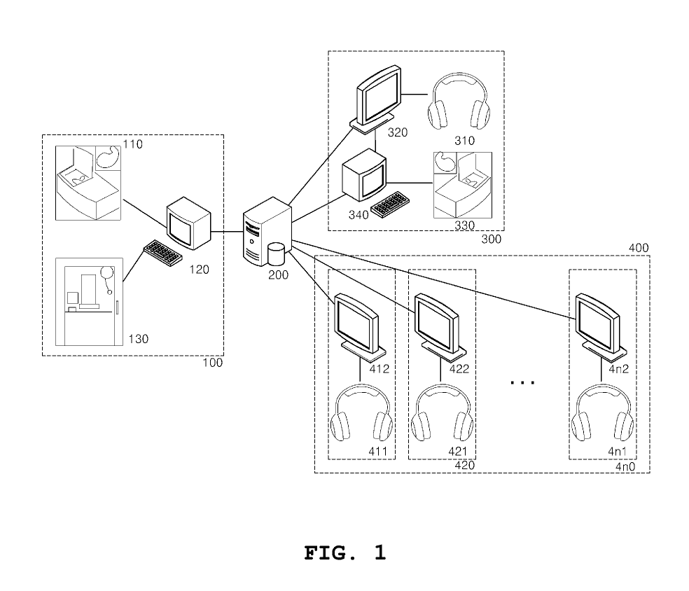

FIG. 1 shows a marketing system for a hearing aid according to an embodiment of the present invention.

Referring to FIG. 1, the marketing system for a hearing aid according to the present invention includes a manufacturing system 100, a marketing server 200, a first selling system 300 and a second selling system 400.

The manufacturing system 100 is a system provided to a hearing aid manufacturer and includes a measuring device 110, an input and control device 120, and a manufacturing device 130. The measuring device 110 is a device for quantitatively measuring shapes and sizes of ear patterns collected from users who use inner ear type hearing aids manufactured in a customized way to generate measurement data, and a 3-dimensional scanner may be used as an example. The input and control device 120 receives the measurement data measured by the ear pattern measuring device 110, and transmits the measurement data to the marketing server 200 together with user information corresponding to the measurement data. The user information may be previously stored in the marketing server 200 by means of the first selling system 300, and in this case, the input and control device 120 may select and store one of a plurality of users so that the measurement data is matched with the stored user information. In addition, the input and control device 120 checks from the marketing server 200 whether measurement data previously measured is present for the user who is willing to purchase a customized inner ear type hearing aid together with the user information of the user. If the measurement data previously measured is present, the measurement data previously measured may be used as it is. However, even though measurement data previously measure is present, if the user wants that a new ear pattern is collected, an additional ear pattern may be collected using the measuring device 110 and measurement data for the additional ear pattern may be generated. In other words, the same user may be matched with several measurement data.

In addition, the input and control device 120 controls the manufacturing device 130 based on the measurement data to manufacture an ear shell suitable for an ear shape of an individual user.

Meanwhile, the input and control device 120 receives representative measurement data generated by statistical treatment of a plurality of measurement data stored in the marketing server 200, and controls the manufacturing device 130 based on the representative measurement data to manufacture a general-purpose inner ear type hearing aid which may be commonly used by a plurality of users.

The existing inner ear type hearing aid should be manufactured in a customized way for each user as described above, but Korean Patent Registration No. 10-1042104, entitled “a method for manufacturing a standard ear shell for an inner ear inserting-type general-purpose hearing aid” (hereinafter, a related document 1) discloses a method for manufacturing a general-purpose inner ear type hearing aid which may be manufactured not in a customized way even though it is an inner ear type hearing aid.

The related document 1 discloses a method for quantitatively measuring ear patterns collected from a plurality of users to generate measurement data, calculating an average of the generated measurement data to calculate average measurement data, and manufacturing a general-purpose inner ear type hearing aid based on the calculated average measurement data.

Even in the present invention, ear patterns collected from a plurality of users are quantitatively measured to calculate representative measurement data, and then a general-purpose inner ear type hearing aid is manufactured based on the representative measurement data, similar to the related document 1. This will be described later.

The input and control device 120 may designate a classification criterion and a statistical treatment method for classifying each value of the measurement data and user information stored in the marketing server 200 and transmit them to the marketing server 200.

The marketing server 200 receives and stores the user information and measurement data from the input and control device 120 and the first selling system 300, and statistically treats the stored user information and measurement data. The marketing server 200 may receive the user information and the measurement data corresponding to the user information together from the input and control device 120 and the first selling system 300, respectively, and may also receive the user information and the measurement data corresponding to the user information individually. For example, the user information may be received from the first selling system 300, and the corresponding measurement data may be received from the input and control device 120. On the contrary, the user information may be received from the input and control device 120, and the corresponding measurement data may be received from the first selling system 300.

The marketing server 200 may variously classify and store the user information according to age, residential area, sex, job or the like, and these classification criterions may be previously set by a manufacturer. In addition, each classified data may be statistically treated.

In addition, the marketing server 200 may calculate the representative measurement data by classifying the stored measurement data according to an important data value previously designated by the manufacturer and performing statistical treatment thereto. As one example of the statistical treatment method for calculating the representative measurement data, an average may be used, but another statistical value may also be used as the statistical treatment method for calculating the representative measurement data according to the manufacturing scheme of the hearing aid manufacturer.

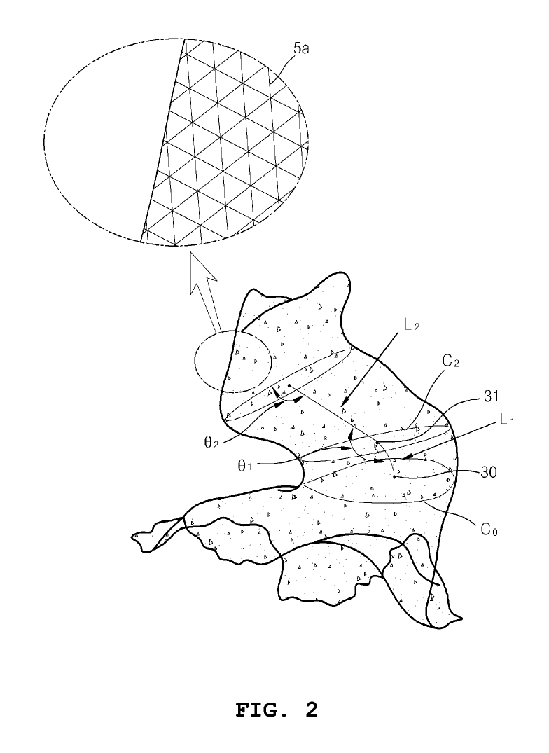

FIG. 2 is a diagram showing an example of the measurement data.

The measurement data shown in FIG. 2 is measurement data measured by scanning the ear pattern using a 3-dimensional scanner, and a volume, length, circumference, angle or the like of the ear pattern may be calculated therefrom. In FIG. 2, C₀ represents a circumference at a sound inlet of the external auditory meatus, C₁ represents a circumference at a first curve of the external auditory meatus, and C₂ represents a circumference at a second curve of the external auditory meatus. In addition, L₁ represents a distance from the inlet center of the external auditory meatus to the center point of the first curve of the external auditory meatus, and L₂ represents a distance from the center point of the first curve of the external auditory meatus to the center point of the second curve of the external auditory meatus. In addition θ₁ represents an angle between L₁ and L₂, and θ₂ represents an angle between L₂ and the circumferential plane of the second curve of the external auditory meatus. The above method for calculating volume, length, circumference and angle of the ear pattern is disclosed in the related document 1 and not described in detail here.

As shown in FIG. 2, the external auditory meatus of a human has a complicated structure and has a deviation for every person. Therefore, rather than manufacturing a general-purpose inner ear type hearing aid by simply using an average value of important data values, the measurement data is classified into a plurality of groups according to data values, each classified group is statistically treated to calculate representative measurement data, and a general-purpose inner ear type hearing aid is manufactured based on the calculated representative measurement data so as to provide inner ear type hearing aids suitable for more users. Here, the representative measurement data may not be an average of a plurality of measurement data, and a statistical value such as a minimum or maximum value may be used as the representative measurement data. In addition, the statistical method for calculating a representative value may be corrected by the input and control device 120 according to the satisfaction fed-back to the marketing server through at least one first selling system 300 or a plurality of second selling systems 400.

The first selling system 300 is a system provided at a hearing aid specialty store, and includes a hearing examining device 310, a fitting device 320, a measuring device 330 and a data input device 340.

The hearing examining device 310 is a device for examining the hearing of a user and transmits a hearing examination result of the user to the fitting device 320 as hearing data. The fitting device 320 is a device for adjusting a sound amplification characteristic of a hearing aid selected by a user and adjusts the sound amplification characteristic of the connected hearing aid according to the hearing data of the user applied from the hearing examining device 310. In addition, the fitting device 320 may additionally adjust the adjusted sound amplification characteristic according to an external command. Furthermore, the fitting device 320 transmits the adjusted sound amplification characteristic as fitting data to the marketing server 200 or to the data input device 340. When transmitting the fitting data, the fitting device 320 may transmit the hearing examination data applied from the hearing examining device 310 together.

The measuring device 330 quantitatively measures the shape and size of the ear pattern collected from users to generate measurement data and transmits the measurement data to the data input device 340, similar to the measuring device 110 of the manufacturing system. The data input device 340 receives the user information and transmits the user information to the marketing server 200, and if the measurement data is applied from the measuring device 330, the data input device 340 matches the measurement data with the user information and transmits them to the marketing server 200. In addition, the fitting data applied from the fitting device 320 may be transmitted to the marketing server 200. Furthermore, in a case where the hearing examination data is applied, the hearing examination data may also be transmitted to the marketing server 200.

As described above, since the first selling system 300 is a system provided at a hearing aid specialty store, a user may perform a hearing examining process or a fitting process with the help of a specialist.

In addition, even though it has been described that the measuring device 330 is included in the first selling system 300, since the measuring device 110 is provided at the manufacturing system 100, the first selling system 300 may not be provided with the measuring device 330. In addition, even though it has been described that the data input device 340 is provided separately from the fitting device 320 and receives the user information and the measurement data, the data input device 340 may be configured to include the fitting device 320.

In the present invention, the first selling system 300 is a system for a hearing aid specialty store which sells inner ear type hearing aids basically manufactured in a customized way, and since a specialist is located at the hearing aid specialty store, an ear pattern of a user may be collected. Therefore, the collected ear pattern may be directly measured using the measuring device 330 or transmitted to the manufacturer to be measured using the measuring device 110 of the manufacturing system so that measurement data is generated. The measurement data measured as above is used as data for updating the representative measurement data used for manufacturing a general-purpose inner ear type hearing aid.

Even though only one first selling system 300 is depicted in FIG. 1, the hearing aid selling system according to the present invention may include a plurality of first selling systems.

The second selling system 400 includes a plurality of simple selling systems 410 to 4n0. The plurality of simple selling systems 410 to 4n0 may be respectively provided at a simple hearing aid store, and each of the plurality of simple selling systems 410 to 4n0 includes a hearing examining device 411 to 4n1 and a fitting device 412 to 4n2.

The hearing examining device 411 to 4n1 examines a hearing state of a user and transmits a hearing examination result as hearing data to the corresponding fitting device 412 to 4n2, similar to the hearing examining device 310 of the first selling system 300. In addition, the fitting device 412 to 4n2 adjusts a sound amplification characteristic of the connected hearing aid according to the hearing data of the user applied from the hearing examining device 411 to 4n1.

Even though the existing hearing examination needs the help of a specialist, since the performance of the hearing examining device 411 to 4n1 is improved recently and a graphic user interface (GUI) is applied to the hearing examining device 411 to 4n1, hearing may be examined without any help of a specialist. In addition, the fitting device 412 to 4n2 may automatically perform a fitting work to the connected hearing aid according to the hearing data applied from the hearing examining device 411 to 4n1, and the fitting device 412 to 4n2 has a selective fitting adjustment function so that the sound amplification effect may be exhibited suitable for the taste of the user or the circumstance. As the fitting device 412 to 4n2 is also provided with a graphic user interface, the selective fitting adjustment work may be easily performed by any person. In other words, a user may perform hearing examination and fitting work without any help of a specialist.

In addition, the fitting device 412 to 4n2 may receive the user information from a user and transmits the user information to the marketing server 200. In other words, the fitting device 412 to 4n2 may also serve as the data input device 340. Accordingly, the marketing server 200 may receive and store the fitting data together with the user information. Therefore, the fitting device 412 to 4n2 checks whether fitting data previously transmitted is present corresponding to the user information from the marketing server 200, and, if the previously transmitted fitting data is present, the fitting device 412 to 4n2 may check whether the user wants to perform the fitting work in the same way as previously. In addition, the satisfaction and improvements of the general-purpose inner ear type hearing aid may be received and transmitted to the marketing server 200 as feed-back data so that the manufacturer improves the general-purpose inner ear type hearing aid. In a case where the fitting device 412 to 4n2 has only a fitting function, the fitting device 412 to 4n2 of the second selling system 400 may be provided to be separated into a data input device and a fitting device, similar to the first selling system 300.

Therefore, a user may perform all works in person without any help of a specialist, except for collecting an ear pattern according to the shape of the external auditory meatus of the user and generating measurement data. In addition, since the general-purpose inner ear type hearing aid is manufactured based on the representative measurement data generated by statistical treatment of the measurement data previously measured for a plurality of users, it is not necessary to collect an ear pattern. In other words, the general-purpose inner ear type hearing aid is not individually manufactured according to each user but may be mass-produced based on the representative measurement data. Therefore, the production cost of the hearing aid is greatly reduced, which may decrease the price of the hearing aid. In addition, the general-purpose inner ear type hearing aid may be manufactured with various sizes and shapes by means of statistical treatment of each grouped measurement data. Therefore, a user may directly wear and select a suitable one of a plurality of general-purpose hearing aids and then fit the selected hearing aid in person.

As a result, in the present invention, since the simple hearing aid store having a plurality of simple selling systems 410 to 4n0 does not require a specialist, the simple hearing aid store may be implemented at a place allowing each access of users in a form of a partition-type shop in a department store, a discount store or a supermarket. Accordingly, a user may instantly select, fit and wear a suitable hearing aid at a place easily accessed. In addition, if the data for the general-purpose inner ear type hearing aid previously selected by the user is stored in the marketing server 200, the marketing server 200 may inform the size and shape of the general-purpose inner ear type hearing aid, previously selected by the user, through the fitting device 412 to 4n2, and may additionally inform a general-purpose inner ear type hearing aid with similar size and shape to the general-purpose inner ear type hearing aid previously selected by the user, among a plurality of general-purpose inner ear type hearing aid with various sizes and shapes.

If the user has high satisfaction for the general-purpose inner ear type hearing aid previously used, the user is willing to select and use the same general-purpose inner ear type hearing aid as previous. However, the general-purpose inner ear type hearing aid is not a product optimized for the user, different from a customized inner ear type hearing aid. Therefore, the user may wish to purchase a different kind of general-purpose inner ear type hearing aid from the previous general-purpose inner ear type hearing aid. However, since the actual shape of the external auditory meatus of a person is not seriously different, it is unnecessary for the user to wear and test all kinds of hearing aids. Therefore, in the present invention, the marketing server 200 may inform a designated number of general-purpose inner ear type hearing aids with similar sizes and shapes together with the general-purpose inner ear type hearing aid previously used by the user so as to reduce the time taken for the user to select the general-purpose inner ear type hearing aid.

In addition, since even a person with no specialized knowledge about the hearing aid may operate the simple hearing aid store, the number of hearing aid stores may increase.

Additionally, even though the hearing aid is manufactured by combining various parts such as a microphone, an amplifier, a receiver and a sound adjustment unit, those parts are mostly attached on a printed circuit board, which may be performed regardless of the shape of the external auditory meatus of the user. In addition, since the working process is relatively easier than the ear shell manufacturing process, mass production is possible.

However, due to the size of the inner ear type hearing aid, the printed circuit board should have a very small size, and the work of attaching all parts required for the hearing aid to the small-sized printed circuit board also demands high precision, which deteriorates a production rate of the hearing aid, makes it difficult to maintain the quality of the hearing aid, and increase a manufacturing cost.

Therefore, the present invention utilizes the Korean Patent Registration No. 10-0795306, entitled “a method for manufacturing a face plate for an inner ear hearing aid” (hereinafter, referred to as a related document 2). The related document 2 discloses a method for manufacturing a hearing aid, which inserts and fixes parts required for the hearing aid, such as a microphone, an amplifier, a receiver and a sound adjustment unit, to a flexible printed circuit board which may be folded, and then folds the flexible printed circuit board and attaches it to a face plate so that the printed circuit board to which the parts are inserted and fixed may have a great size, thereby ensuring easy manufacture to allow mass production and decreasing a size of the inner ear type hearing aid.

Even though it has been described above just on the marketing system for the inner ear type hearing aid, since hearing aids other than the inner ear type hearing aid are manufactured regardless of the shape of the external auditory meatus of the user, they may be manufactured and sold in the same way as the general-purpose inner ear type hearing aid. In other words, both of the hearing aid specialty store and the simple hearing aid store may manufacture and sell not only the inner ear type hearing aid but also other type hearing aids. In addition, even though it has been described that only hearing aids manufactured in a customized way are sold in the hearing aid specialty store, general-purpose inner ear type hearing aids may also sold.

In addition, even though the manufacturing system 100 has been described separately from the first selling system 300 for convenience, the first selling system 300 may be integrated into the manufacturing system 100. In other words, the manufacturer and the hearing aid specialty store may be integrated. Furthermore, the simple selling systems 410 to 4n0 of the second selling system 400 may be included in the first selling system 300.

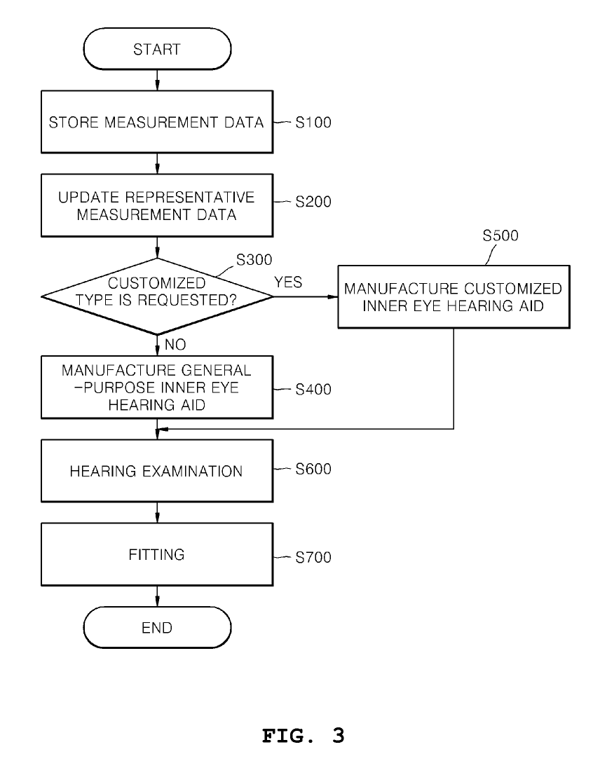

FIG. 3 shows a marketing method for a hearing aid according to an embodiment of the present invention.

Referring to FIG. 3, first, in the manufacturing system 100 and the first selling system 300, the measurement data generated by quantitatively measuring shapes and sizes of ear patterns collected from a plurality of users by using the measuring devices 110 and 330 is matched corresponding user information and stored in the marketing server 200 (S100).

The measurement data stored in the marketing server 200 is divided into one or more groups according to a predetermined pattern, and statistical treatment is performed to each divided group to update a plurality of representative measurement data (S200).

After that, the marketing server 200 determines whether the user requests a customized inner ear type hearing aid (S300).

In a case where the user requests a customized inner ear type hearing aid, the marketing system 200 transmits the stored measurement data to the manufacturing system 100, and the manufacturing system 100 manufactures a customized inner ear type hearing aid based on the received measurement data (S500).

However, in a case where the user does not request a customized inner ear type hearing aid, the manufacturing system 100 receives a plurality of representative measurement data generated by the marketing server 200, and manufactures a general-purpose inner ear type hearing aid with size and shape corresponding to each of the plurality of received representative measurement data (S400).

If the manufactured customized inner ear type hearing aid is disposed at the first selling system 300, the user visits the hearing aid specialty store and performs hearing examination by using the hearing examining device 310 to generate hearing data (S600).

Meanwhile, if the general-purpose inner ear type hearing aid is disposed at a plurality of simple hearing aid stores of the second selling system 400, the user visits one of the plurality of simple hearing aid store, which may be easily accessed, and selects a suitable general-purpose inner ear type hearing aid while wearing a plurality of general-purpose inner ear type hearing aids provided at the simple hearing aid store. After that, the user connects to the simple selling system 410 to 4n0. The user inputs the user information and the kind of the selected general-purpose inner ear type hearing aid, and performs hearing examination by using the hearing examining device 411 to 4n1 to generate hearing data.

The generated hearing data is applied to the fitting device 320 and 412 to 4n2 and stored in the marketing server 200 (S600).

The fitting device 320 and 412 to 4n2 performs a fitting work to the general-purpose inner ear type hearing aid selected by the user, in a response to the hearing data, and stores a result of the fitting work as fitting data in the marketing server 200 (S700).

As described above, in the present invention, the plurality of simple hearing aid stores of the second selling system 400 are provided at places which may be easily accessed by users. The existing customized inner ear type hearing aid needs the help of a specialist when a user wants to purchase a hearing aid, and therefore it is able to be sold only at places where specialists are present. In other words, a user should visit a hearing aid specialty store equipped with the first selling system 300. In addition, since it is required to collect an ear pattern of the user and generate a hearing aid corresponding to the collected ear pattern, the hearing aid may not be instantly used when the user desires it. However, in the present invention, in a case where a user wants to purchase a hearing aid, the user may select a hearing aid with a suitable appearance and fit the selected hearing aid without any help of a specialist. In the present invention, since a user does not need the help of a specialist when purchasing a hearing aid, general-purpose inner ear type hearing aids may be exhibited at busy places such as small stores, supermarkets, discount stores and department stores to enhance the easy access of users. In addition, since general-purpose inner ear type hearing aids are not manufactured or sold at specialty stores but may be supplied to and sold at supermarkets, discount stores and department stores which already have distribution networks for other products, the price of hearing aids may be further lowered, which may contribute to the propagation of hearing aids.

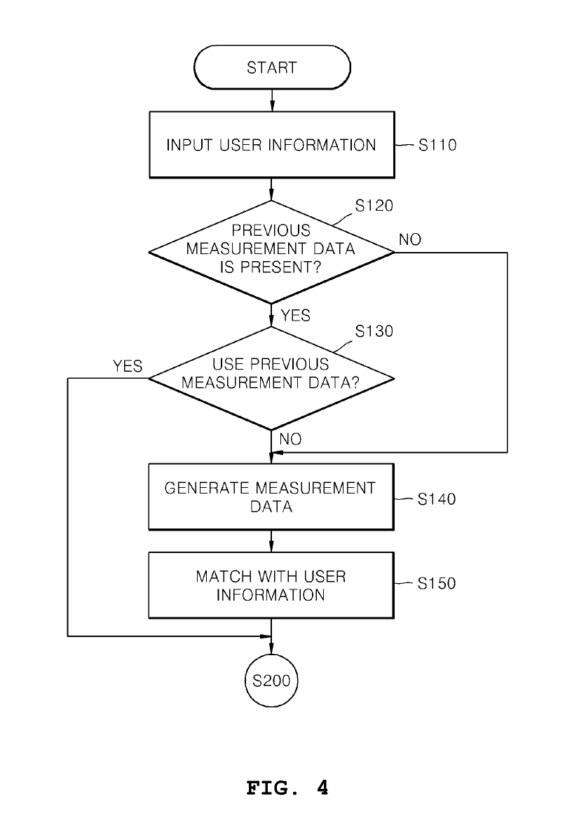

FIG. 4 is a diagram showing the measurement data storing operation of FIG. 3 in detail.

The measurement data is data collected for manufacturing a customized hearing aid.

The measurement data has a premise that a user visits a manufacturer or hearing aid specialty store to collect an ear pattern. If a user visits a manufacturer or hearing aid specialty store, the user information is input using the manufacturing system 100 or the first selling system 300, and the input user information is stored in the marketing server 200 (S110).

After the user information is input, it is determined whether previous measurement data for the user is present in the marketing server 200 (S120). If no previously stored measurement data is present, measurement data is generated (S 140). However, if previous measurement data is stored in the marketing server 200, it is determined whether or not to use the previously stored measurement data (S130). In a case where the previous measurement data is used, it is not necessary to newly generate measurement data. However, in a case where the previous measurement data is not used, measurement data is generated (S140). In this case, the ear pattern collected from the user is measured by using the measuring device 110 and 330 to generate the measurement data. Here, if the first selling system 300, namely the hearing aid specialty store, is not equipped with the measuring device 330, the hearing aid specialty store allows the measuring device 110 of the manufacturing system 100 to generate the measurement data by inputting only the user information and transmitting the collected ear pattern to the manufacturer.

The generated measurement data is matched with the corresponding user information and stored in the marketing server 200 (S150).

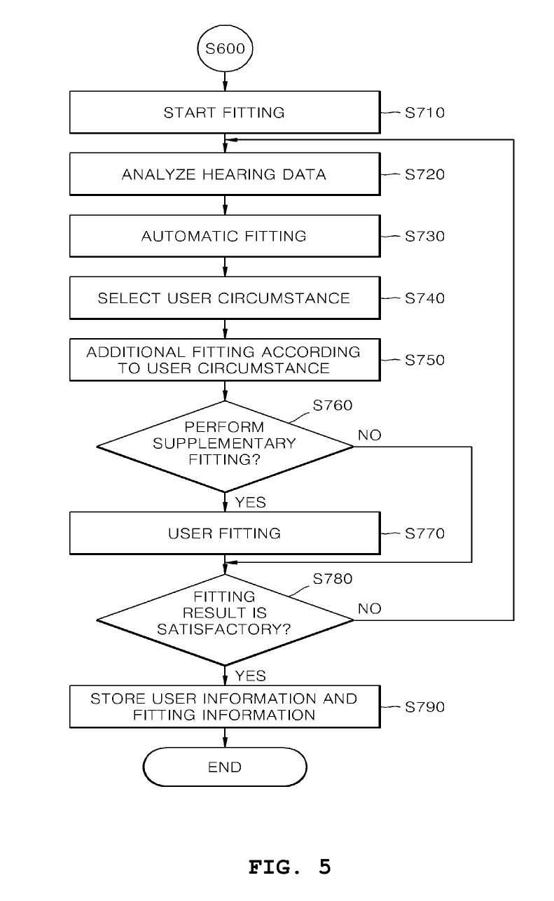

FIG. 5 is a diagram showing the fitting operation of FIG. 3 in detail.

Recently, most hearing aids are equipped with microprocessors and operated in a digital manner. In addition, the fitting work may be performed in an easier way for the hearing aid operated in a digital manner rather than for a hearing aid operated in an analog manner. Furthermore, the development of hardware and software of the fitting device provides easy and various circumstances for the fitting work so that a user may directly fit the hearing aid.

Referring to FIG. 5, the fitting work includes, firstly, a fitting start operation (S710) where a user operates the fitting device. The fitting start operation (S710) allows the user to select a start button of the fitting device and makes the fitting device perform the fitting work. Recent fitting devices provide a graphic user interface, and buttons of the fitting devices may be implemented as not only physical switches or buttons but also icons on a touch screen which may be selected by a touch. Here, the user should mount a selected hearing aid to the fitting device to be fit, and the user may wear a hearing examining device, provided in the fitting device, on the ear so as to perform hearing examination of the user. In addition, the user may additionally input the user information in the fitting start operation (S710).

If the fitting operation starts, the fitting device 412 to 4n2 firstly analyzes the hearing data applied from the hearing examining device 411 to 4n1 (S720). In other words, the hearing data is analyzed to check a hearing state of the user.

After that, based on the fitting, the fitting device performs an automatic fitting operation (S730) for fitting a sound amplification characteristic of the hearing aid selected by the user. The automatic fitting operation (S730) simply performs only the fitting work according to the hearing state and is a generalized fitting work. Additionally fitting may be required according to the circumstance where the user generally uses the hearing aid. Accordingly, if the automatic fitting is completed, a circumstance where the hearing aid is generally used is selected (S740). User circumstances may be set and provided in the fitting device in advance. The user selects a suitable one among a plurality of user circumstances provided by the fitting device, and the fitting device performs the additional fitting work according to the selected user circumstance (S750).

If the additional fitting work is completed, it is checked whether a supplementary fitting work according to a taste of the user is performed (S760). In a case where the user does not want a supplementary fitting work, the fitting work is completed. However, in a case whether the user wants a supplementary fitting work, a user fitting work starts (S770). For the user fitting work, the fitting device displays a user selection window so that the user may select a fitting type to be performed. The user selection window displays sound samples (e.g., a wind sound, a water sound, a vehicle sound, or the like) to be directly adjusted by the user so that the user may select a window for a desired sound and adjust the sound, and a frequency-based adjustment window may also be provided for users with specialized knowledge. The user directly performs the user fitting work by using the displayed user selection window (S770).

If the user fitting is completed, the user checks the fitting result and determines whether the fitting result is satisfactory (S780).

If the user satisfies the fitting result, the fitting information is stored in the fitting device together with the user information, and then the fitting work is completed (S790). However, if the fitting result is not satisfactory, the user may performs the fitting work again from the hearing examination operation (S720).

In addition, the stored user information and fitting information may be utilized for after-sales service of the hearing aid later, and may also be utilized as database for manufacturing general-purpose hearing aids. The information of the selected hearing aid may be stored together to analyze kinds, sizes and shapes of hearing aids desired by users and reflected when new hearing aids are developed.

In addition, even though only the inner ear type hearing aid has been illustrated in FIGS. 3 to 5, similar to the general-purpose inner ear type hearing aid, the method used for the general-purpose inner ear type hearing aid may be identically applied to other kinds of hearing aids which do not require an ear pattern of a user.

The system according to the present invention may be implemented on a computer-readable recording medium as computer-readable codes. The computer-readable recording medium includes all kinds of recording devices on which data readable by a computer system is stored. The recording medium may be, for example, ROM, RAM, CD-ROM, magnetic tapes, floppy disk, optical data storage, or the like, and a device implemented in a form of carrier wave (for example, transmission through Internet) may be included. In addition, the computer-readable recording medium may be distributed in computer systems connected through a network so that the computer-readable codes may be read in a distributed way.

The marketing method for a hearing aid according to the present invention allows a user to purchase a suitable general-purpose inner ear type hearing aid without any help of a specialist and use it instantly. Therefore, manufacturing and selling costs may be greatly reduced, and the hearing aid market may be expanded since hearing aids may be purchased at places ensuring easy access of users.

Though the present invention has been described above based on limited embodiments shown in the drawings, the above disclosure is provided just for better understanding of the present invention, and it is obvious to those having ordinary skill in the art that various modifications and other equivalent embodiments can be made from the above disclosure.

Therefore, the scope of the present invention should not be defined by the spirit of the appended claims.

What is claimed is:

1. A marketing system for a hearing aid, comprising:
a manufacturing system for generating a plurality of measurement data for each of a plurality of collected ear patterns, and manufacturing a customized inner ear type hearing aid corresponding to the plurality of measurement data and a general-purpose inner ear type hearing aid corresponding one or more representative measurement data;
a marketing server for receiving and storing the plurality of measurement data and first and second user information respectively corresponding to the plurality of measurement data, classifying the plurality of stored measurement data into one or more groups according to a predetermined pattern, and then statistically treating the plurality of measurement data of each group to generate the representative measurement data;
a first selling system for receiving the first user information for a first user who wants to use the customized inner ear type hearing aid and transmitting the first user information to the marketing server, and transmitting first hearing data which is a hearing examination result of the user and first fitting data which is a fitting result of the customized inner ear type hearing aid according to the first hearing data to the marketing server; and
a second selling system for receiving the second user information for a second user who wants to use general-purpose inner ear type hearing aid and transmitting the second user information to the marketing server, and transmitting second hearing data which is a hearing examination result of the second user and second fitting data which is a fitting result of the general-purpose inner ear type hearing aid according to the second hearing data to the marketing server.

2. The marketing system for a hearing aid according to claim 1, wherein the manufacturing system includes:
a first measuring device for quantitatively measuring each of the plurality of collected ear patterns to generate the plurality of measurement data;
an input and control device for receiving the measurement data and transmitting the measurement data to the marketing server, and receiving the measurement data and the representative measurement data applied from the marketing server; and
a manufacturing device for manufacturing the customized inner ear type hearing aid corresponding to the measurement data and manufacturing a general-purpose inner ear type hearing aid corresponding to the representative measurement data, by the control of the input and control device.

3. The marketing system for a hearing aid according to claim 2, wherein, when the measurement data is added, the marketing server includes the added measurement data in a corresponding one of the one or more groups and then statistically treating a plurality of measurement data included in the added measurement data to update the representative measurement data.

4. The marketing system for a hearing aid according to claim 3, wherein the first selling system includes:
a first hearing examining device for performing hearing examination to the first user to generate the first hearing data;
a first fitting device for fitting the customized inner ear type hearing aid based on the first hearing data and generating first fitting data; and
a data input device for transmitting the first user information for the first user, the first hearing data and the first fitting data to the marketing server.

5. The marketing system for a hearing aid according to claim 4,
wherein the first selling system further includes a second measuring device for quantitatively measuring an ear pattern of the first user to generate measurement data, and
wherein the data input device receives the measurement data and transmits the measurement data to the marketing server.

6. The marketing system for a hearing aid according to claim 4, wherein the first selling system is implemented at a hearing aid specialty store.

7. The marketing system for a hearing aid according to claim 4, wherein the second selling system includes:
a second hearing examining device for performing hearing examination to the second user to generate the second hearing data; and
a second fitting device for fitting the general-purpose inner ear type hearing aid based on the second hearing data to generate the second fitting data, and transmitting the second fitting data to the marketing server.

8. The marketing system for a hearing aid according to claim 7, wherein the second fitting device further includes a data input device for receiving second user information of the second user and transmitting the second user information to the marketing server.

9. The marketing system for a hearing aid according to claim 7, wherein the second selling system is implemented at a simple hearing aid store, and the simple hearing aid store is included in any one of department stores, supermarkets and discount stores.

10. A marketing method for a hearing aid of a hearing aid marketing system including a manufacturing system, a marketing server, a first selling system and a second selling system, the marketing method comprising:
storing a plurality of measurement data applied from the manufacturing system to the marketing server;
performing statistical treatment to the plurality of stored measurement data to update one or more representative measurement data;
the manufacturing system manufacturing a customized inner ear type hearing aid based on measurement data corresponding to the user among the plurality of measurement data or a general-purpose inner ear type hearing aid based on the representative measurement data according to a request of the user;
examining hearing of the user by means of a hearing examining device provided at the first selling system or the second selling system to generate hearing data; and
fitting the customized inner ear type hearing aid and the general-purpose inner ear type hearing aid by means of a fitting device provided at the first selling system or the second selling system in a response to the hearing data.

11. The marketing method for a hearing aid according to claim 10, wherein said storing of the plurality of measurement data includes:
inputting user information of the user by means of the first and second selling systems;
determining whether measurement data for the user, previously stored, is present in the marketing server;
determining whether or not to use the previous measurement data, in a case where the previous measurement data is present;
measuring an ear pattern of the user to generate the measurement data in a case where the previous measurement data is not present in the manufacturing system or in a case where the previous measurement data is present but is not used; and
storing the generated measurement data in the marketing server to be matched with the stored user information.

12. The marketing method for a hearing aid according to claim 10, wherein said updating of the representative measurement data includes:
classifying the plurality of measurement data into one or more groups according to a predetermined pattern;
statistically treating a plurality of measurement data of each group to generate the one or more representative measurement data;
when new measurement data is additionally applied, including the added measurement data in one of the plurality of groups; and
further statistically treating the group including the added measurement data to update representative measurement data corresponding to the group.

13. The marketing method for a hearing aid according to claim 10, wherein said fitting includes:
starting the fitting to operate the fitting device;
analyzing hearing data applied from the hearing examining device;
automatically fitting the customized inner ear type hearing aid and the general-purpose inner ear type hearing aid connected to the fitting device in a response to the analyzed hearing data;
selecting a user circumstance where the automatically fit hearing aid is generally used;
performing additional fitting to the automatically fit hearing aid according to the user circumstance;
determining whether or not to perform supplementary fitting to the hearing aid to which the additional fitting is performed;
performing supplementary fitting according to a setting of the user, in a case where the supplementary fitting is to be performed;
checking a fitting result of the hearing aid to which the additional fitting or supplementary fitting is performed; and
storing the fitting result in the marketing server to be matched with the user information.
